(19) United States
(12) Patent Application Publication
(10) Pub. No.: US 2006/0257663 A1
(43) Pub. Date: Nov. 16, 2006

(54) Wear resistant coatings to reduce ice adhesion on air foils

(76) Inventors: Gary L. Doll, Canton, OH (US); Ryan D. Evans, North Canton, OH (US); Elizabeth P. Cooke, Canal Fulton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/547,576

(22) PCT Filed: Feb. 12, 2004
(86) PCT No.: PCT/US04/04179

§ 371 Date: Aug. 31, 2005

Related U.S. Application Data
(60) Provisional application No. 60/451,459, filed on Mar. 3, 2003.

(51) Int. Cl. B32B 7/02; B32B 9/00

(52) U.S. Cl. 428/408; 428/212

(57) ABSTRACT

A hard, wear resistant and ice-phobic coating (10) can be applied to an air foil surface (12) in a single application to enhance the deicing of the surface. The coating includes a functional top layer (14) which is harder than the air foil surface and has high contact angle with water. The functional layer contains carbon (>35 atomic %) and hydrogen (0-40 atomic %) in a diamond-like carbon, glassy, or amorphous configuration, as well as incorporated silicon and oxygen (0.1-40 atomic % each).

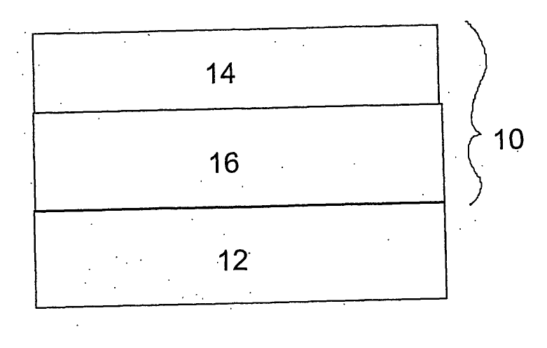

### CROSS-REFERENCE TO RELATED APPLICATIONS

This application claims benefit of and priority to U.S. Ser. No. 60/451,439 filed on Mar. 3, 2003.

### TECHNICAL FIELD

This invention relates to wear resistant coatings, and in particular, to such a coating which is hydrophobic and ice-phobic and can be applied to air foils to reduce the adhesion of ice on the air foils.

### BACKGROUND ART

“Airfoil” is defined as any surface that is designed to produce reaction forces from the air through which it moves, such as wing and propeller leading edges and surfaces. “Airfoil” can also include aircraft fuselages.

Ice on air foils changes the shape of the air foil surfaces and adversely affects the aerodynamics of air foils. Hence, removal of air foil surface, or treatment of the air foil surfaces prior to flight is required in any circumstance in which the aircraft has, or will encounter, icing conditions. Existing deicing technologies require frequent re-application of special fluids or surfactants (such as liquid chemical/antifreeze sprays) that aid in deicing for a short time but ultimately do not protect the underlying surface. Other existing deicing technologies include mechanical induction-coil shock deicers and forced hot air heat exchange deicers. Patents also exist for the use of Teflon-like fluorocarbon polymer coatings to reduce ice adhesion.

### SUMMARY OF THE INVENTION

A hard, ice-phobic coating is provided which can be applied to air foil surfaces to reduce ice adhesion on the air foil surfaces. The coatings have a functional top layer that is about 0.1-10 μm thick and which may be deposited directly onto the substrate, a gradient (or transition) layer, and/or adhesive interlayer(s). The functional top layer is harder than the underlying substrate (preferably having a hardness greater than about 7 GPa as measured by nanoindentation). The functional layer has a low surface energy (preferably less than about 50 mN/m) and high contact angle with water (preferably greater than about 600). The functional layer contains carbon (greater than about 35 atomic %) and hydrogen (about 0-40 atomic %) in a diamond-like carbon, glassy, or amorphous configuration, as well as incorporated silicon and oxygen (about 0.1-40 atomic % each).

The functional layer is deposited using low-pressure plasma vapor deposition technologies such as plasma enhanced chemical vapor deposition (PECVD), chemical vapor deposition (CVD), physical vapor deposition (PVD or “sputtering”), and/or reactive sputtering. The subject thin, solid, wear resistant coatings may be deposited onto airfoil surfaces and/or onto other deicing apparatus present on airfoil surfaces in order to reduce ice adhesion and wear of the underlying substrate.

### BRIEF DESCRIPTION OF DRAWINGS

The FIGURE is a cross-sectional view of a coating of the present invention applied to an airfoil surface.

### BEST MODE FOR CARRYING OUT THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

We propose the use of solid wear resistant coatings 10 on airfoil surfaces 12 to protect the underlying surfaces from wear (e.g., erosion), and to reduce ice adhesion thus ultimately decreasing the amount of energy and/or chemicals needed for deicing.

The coating 10 comprises a functional top layer 14 that is about 0.1 μm to about 10 μm thick. The functional top layer can be deposited directly onto the substrate. Alternatively, an intermediate layer 16 can be applied to the airfoil surface 12, and the functional top layer 14 will be applied to the intermediate layer 16. This intermediate layer can be a gradient (or transition) layer and/or one or more adhesive interlayers. In either event, the functional top layer 14 can be deposited using low-pressure plasma vapor deposition technologies such as plasma enhanced chemical vapor deposition (PECVD), chemical vapor deposition (CVD), physical vapor deposition (PVD or “sputtering”), and/or reactive sputtering.

The functional top layer 14 is harder than the underlying substrate 12. Preferably, the top layer 14 has a hardness greater than about 7 GPa as measured by nanoindentation. The functional top layer also has a low surface energy (preferably less than about 50 mN/m) and high contact angle with water (preferably greater than about 60°).

Preferably, the functional top layer 14 comprises carbon, hydrogen, silicon, and oxygen. The carbon is present in an amount >35 atomic %; the hydrogen is present in an amount from 0-40 atomic %; and the incorporated silicon and oxygen are present in an amount of 0.1-40 atomic % each. The carbon and hydrogen (if present) are formed in a diamond-like carbon, glassy, or amorphous configuration. The silicon and oxygen are incorporated into the carbon/hydrogen composition.

The subject thin, solid, wear resistant coatings may be deposited onto airfoil surfaces and/or onto other deicing apparatus present on airfoil surfaces in order to reduce ice adhesion and wear of the underlying substrate.

The functional top layer has been found to be ice-phobic. This thin, solid, ice-phobic, wear resistant coating has a low adhesion to ice, thereby allowing for easy removal of ice or snow accumulation from a coated surface. The coating is applied one time and has a long life, even in harsh environments, due to its chemical inertness, high hardness, excellent wear resistance properties. The performance of expensive mechanical and electrical deicing apparatus may be enhanced if they are protected by a hard, ice-phobic coating. An unexpected result of this invention is that, unlike popular fluorocarbon polymers, the subject carbon-hydrogen-silicon-oxygen thin films are simultaneously “ice-phobic/hydrophobic” and hard. Fluorocarbon polymers which have been used in the past are “soft” (and thus susceptible to wear/erosion) and contain environmentally unfriendly fluorine.

As various changes could be made in the above constructions without departing from the scope of the invention, it is intended that all matter contained in the above description or shown in the accompanying drawings shall be interpreted as illustrative and not in a limiting sense.

1. An ice-phobic wear resistant coating (10) for use in reducing ice adhesion on airfoil surfaces (12); the coating comprising a functional layer (14) comprising more than about 35 atomic % carbon and about 0-40 atomic % hydrogen in an amorphous diamond-like carbon configuration, and incorporating about 0.1-40 atomic % silicon and about 0.1-40 atomic % oxygen; the coating having a thickness of about 0.1-10 μm, a contact angle with water of more than about 60°, and a hardness greater than the hardness of the surface to which the coating is applied, said hardness being at least 7 GPa as measured by nanoindentation.

2. (canceled)

3. The coating of claim 1 wherein the coating has a surface energy of less than about 50 mN/m.

4. (canceled)

5. The coating of claim 1 wherein the functional layer is deposited on a substrate using low-pressure plasma vapor deposition technologies such as plasma enhanced chemical vapor deposition (PECVD), chemical vapor deposition (CVD), physical vapor deposition (PVD or “sputtering”), and/or reactive sputtering.

6. The coating of claim 1 further including a gradient (or transition) layer (16), and/or adhesive interlayer(s) between the substrate and the functional coating.
